(19) United States
(12) Patent Application Publication
(10) Pub. No.: US 2015/0160777 A1
(43) Pub. Date: Jun. 11, 2015

(54) INFORMATION PROCESSING METHOD AND ELECTRONIC DEVICE

(71) Applicant: Beijing Lenovo Software Ltd., Beijing (CN)

(72) Inventors: Rui Lu, Beijing (CN); Xiaohui Xie, Beijing (CN)

(21) Appl. No.: 14/493,834

(22) Filed: Sep. 23, 2014

(30) Foreign Application Priority Data
Dec. 9, 2013 (CN) 201310660983.7

(51) Int. Cl. G06F 3/041; G06F 3/045; G06F 3/044

(52) U.S. Cl. CPC G06F 3/0416; G06F 3/044; G06F 3/045; G06F 2203/04104

(57) ABSTRACT

The present invention discloses an information processing method and an electronic device for solving a technical problem that conventionally, a single hand cannot implement a multipoint touch control operation in some usage environments. The method comprises: detecting a first touch control operation of a first operator on a first position of the touch control display unit; determining whether the first touch control operation meets a first predetermined condition, so as to obtain a first determination result; controlling the first position to be in a touch-controlled state so as to become a first touch control point, if the first determination result indicates that the first touch control operation meets the first predetermined condition; detecting at least one second touch control operation for at least one object in an area of the touch control display unit, during the time when the first position is in the touch-controlled state; generating and executing a control instruction based on the first touch control point and the at least one second touch control operation, so as to perform a control operation corresponding to the control instruction on the at least one object.

### CROSS REFERENCE TO RELATED APPLICATION

This application claims priority to the Chinese Application No. 201310660983.7, filed on Dec. 9, 2013, which is incorporated herein by reference in its entirety.

### TECHNICAL FIELD

The present disclosure relates to an electronic technique field, and particularly, to an information processing method and an electronic device.

### BACKGROUND

With the development of touch control technology, an increasing number of touch control devices, such as smart phones, tablets, notebooks etc., enter people's lives. The touch control technology greatly facilitates the people to operate and control the electronic device.

To allow user's experience to be more realistic and more interesting during a touch control operation, a current touch control display screen may support the user's multipoint touch control. That is, the touch control screen may respond to operations of multiple touch control points simultaneously. For example, when viewing pictures on a touch control mobile phone, the user may place two fingers on the touch control display screen and move both of the two fingers outward at the same time, so that the picture may be enlarged; or the user may place two hands on the screen of a tablet and move both of the two hands inward at the same time, so that files on a desktop may be put together.

During implementing technical solutions of the present disclosure according to embodiments of the present application, inventors of the present application found that there is a technical problem with the conventional solution that: when the user cannot perform the touch control operation with both hands simultaneously, e.g., when the user needs to hold breakfast with one hand, he can operate the electronic device with only one hand. Then, a single hand cannot complete the multipoint touch control when needed. Therefore, there is a technical problem with the conventional solution that in some usage environments, a single hand cannot complete the multipoint touch control operation.

### SUMMARY

The present disclosure provides an information processing method and an electronic device for solving a technical problem that conventionally, a single hand cannot implement a multipoint touch control operation in some usage environments, and achieves a technical effect of implementing the multipoint touch control operation by the single hand.

In one aspect, the present application provides an information processing method applied in an electronic device, the electronic device including a touch control display unit, the method comprising steps of:

detecting a first touch control operation of a first operator on a first position of the touch control display unit;

determining whether the first touch control operation meets a first predetermined condition, so as to obtain a first determination result;

controlling the first position to be in a touch-controlled state so as to become a first touch control point, when the first determination result indicates that the first touch control operation meets the first predetermined condition;

detecting at least one second touch control operation for at least one object in an area of the touch control display unit, during the time the first position is in the touch-controlled state;

generating and executing a control instruction based on the first touch control point and the at least one second touch control operation, so as to perform a control operation corresponding to the control instruction on the at least one object.

Alternatively, the step of determining whether the first touch control operation meets the first predetermined condition so as to obtain the first determination result is particularly a step of:

determining, according to a first value of a first parameter corresponding to the first touch control operation, whether the first value is larger than a predetermined value, so as to obtain the first determination result.

Alternatively, the step of controlling the first position to be in the touch-controlled state so as to become the first touch control point when the first determination result indicates that the first touch control operation meets the first predetermined condition is particularly steps of:

transmitting, by the touch control display unit, first touch control information corresponding to the first touch control operation to a control unit connected to the touch control display unit;

controlling, by the touch control display unit, the first position to be in the touch-controlled state so as to become the first touch control point, according to a first control signal transmitted by the control unit.

Alternatively, after the step of generating and executing the control instruction based on the first touch control point and the at least one second touch control operation, so as to perform a control operation corresponding to the control instruction on the at least one object, the method further comprises steps of:

obtaining, by the touch control display unit, a duration where the first position is in the touch-controlled state and transmitting the duration to the control unit;

determining, by the control unit, whether the duration is no less than a predetermined period;

transmitting, by the control unit, a second control signal different from the first control signal to the touch control display unit, when the duration is no less than the predetermined period;

controlling, by the touch control display unit, the first position to be adjusted from the touch-controlled state to a non-touch-controlled state, according to the second control signal.

Alternatively, the step of controlling the first position to be in the touch-controlled state so as to become the first touch control point when the first determination result indicates that the first touch control operation meets the first predetermined condition is particularly steps of:

transmitting, by the touch control display unit, the first touch control information at least once to the control unit;

receiving, by the touch control display unit, at least one third control signal transmitted by the control unit;

controlling, by the touch control display unit, the first position to be in the touch-controlled state so as to become the first touch control point, according to the third touch control signal.

Alternatively, after the step of generating and executing the control instruction based on the first touch control point and the at least one second touch control operation, so as to perform a control operation corresponding to the control instruction on the at least one object, the method further comprises steps of:

obtaining, by the touch control display unit, a duration where the first position is in the touch-controlled state, and transmitting the duration to the control unit;

determining, by the control unit, whether the duration is no less than a predetermined period;

transmitting, by the control unit, a second control signal different from the first control signal to the touch control display unit, when the duration is no less than the predetermined period;

controlling, by the touch control display unit, the first position to be adjusted from the touch-controlled state to a non-touch-controlled state, according to the second control signal.

In another aspect, the present application provides an electronic device, comprising:

a first detection unit, configured to detect a first touch control operation of a first operator on a first position of a touch control display unit;

a first determination unit, configured to determine whether the first touch control operation meets a first predetermined condition, so as to obtain a first determination result;

a first control unit, configured to control the first position to be in a touch-controlled state so as to become a first touch control point, when the first determination result indicates that the first touch control operation meets the first predetermined condition;

a second detection unit, configured to detect at least one second touch control operation for at least one object in an area of the touch control display unit, during the time the first position is in the touch-controlled state;

a first performing unit, configured to generate and execute a control instruction based on the first touch control point and the at least one second touch control operation, so as to perform a control operation corresponding to the control instruction on the at least one object.

Alternatively, the first determination unit is particularly a parameter value determination unit, configured to:

determining, according to a first value of a first parameter corresponding to the first touch control operation, whether the first value is larger than a predetermined value, so as to obtain the first determination result.

Alternatively, the first control unit comprises:

a first transmission sub-unit, configured to transmit first touch control information corresponding to the first touch control operation to a control unit connected to the touch control display unit;

a first reception sub-unit, configured to receive a first control signal transmitted from the control unit;

a first control sub-unit, configured to control the first position to be in the touch-controlled state so as to become the first touch control point, according to the first control signal.

Alternatively, the electronic device further comprises:

a first time obtaining unit, configured to obtain a duration in which the first position is in the touch-controlled state and transmitting the duration to the control unit;

a second determination unit, configured to determine whether the duration is no less than a predetermined period;

a first transmission unit, configured to transmit a second control signal different from the first control signal to the touch control display unit, when the duration is no less than the predetermined period;

a second control unit, configured to control the first position to be adjusted from the touch-controlled state to a non-touch-controlled state, according to the second control signal.

Alternatively, the first control unit particularly comprises:

a second transmission sub-unit, configured to transmit the first touch control information at least once to the control unit;

a second reception sub-unit, configured to receive at least one third control signal transmitted by the control unit;

a second control sub-unit, controlling the first position to be in the touch-controlled state so as to become the first touch control point, according to the third touch control signal.

Alternatively, the electronic device further comprises:

a second time obtaining unit, configured to obtain a duration where the first position is in the touch-controlled state, and transmit the duration to the control unit;

a third determination unit, configured to determine whether the duration is no less than a predetermined period;

a second transmission unit, configured to transmit a second control signal different from the first control signal to the touch control display unit, when the duration is no less than the predetermined period;

a third control unit, configured to control the first position to be adjusted from the touch-controlled state to a non-touch-controlled state, according to the second control signal.

The above one or more technical solutions of the embodiments of the present application at least have one or more technical effects as follows:

1. In the technical solutions of the present application, a first touch control operation of a first operator on a first position of the touch control display unit is detected; it is determined whether the first touch control operation meets a first predetermined condition, so as to obtain a first determination result; the first position is controlled to be in a touch-controlled state so as to become a first touch control point, when the first determination result is Yes; at least one second touch control operation is detected when the first position is in the touch-controlled state; a control instruction is generated and executed based on the first touch control point and the second touch control operation. Thus, the technical problem that conventionally, the single hand cannot implement the multipoint touch control operation may be solved, and the technical effect of using the first touch control point for replacing one of touch control points in the multipoint touch control and thus of implementing the multipoint touch control by the single hand may be achieved.

2. In the technical solutions of the present application, the touch control display unit transmits the first touch control information to the control unit, receives first control information transmitted by the control unit, and controls the first position to be in the touch-controlled state according to the first touch control information; the touch control display unit transmits the first touch control information at least once to the control unit, and receives the at least one third control signal transmitted by the control unit, and controls the first position to be in the touch-controlled state according to the third control signal. Thus, the present application provides a plurality of approaches for controlling the first position to be in the touch-controlled state, and achieves the technical effect of implementing the multipoint touch control by the single hand.

3. Further, since the technical solutions of the present application have the technical effects as discussed above, a user experience better than that in the prior art may be obtained, when the user performs the touch control operation on the electronic device.

### BRIEF DESCRIPTION OF THE DRAWINGS

FIG. 1 is a schematic flowchart of an information processing method according to a first embodiment of the present invention;

FIGS. 2A-2B are illustrative diagrams of a first touch control point and a second touch control point in the first embodiment of the present invention;

FIG. 3 is a schematic structure diagram of a first implementation of an electronic device according to a second embodiment of the present invention;

FIG. 4 is a schematic structure diagram of a first implementation of a first control unit according to the second embodiment of the present invention;

FIG. 5 is a schematic structure diagram of a second implementation of the electronic device according to the second embodiment of the present invention; and

FIG. 6 is a schematic structure diagram of a second implementation of the first control unit according to the second embodiment of the present invention.

### DETAILED DESCRIPTION

The present disclosure provides an information processing method and an electronic device for solving the technical problem with the conventional solution that in some usage environments, the single hand cannot complete the multipoint touch control operation.

In order to solve the above technical problem, a principle idea of technical solutions according to embodiments of the present application is:

detecting a first touch control operation of a first operator on a first position of the touch control display unit;

determining whether the first touch control operation meets a first predetermined condition, so as to obtain a first determination result;

controlling the first position to be in a touch-controlled state so as to become a first touch control point, when the first determination result indicates that the first touch control operation meets the first predetermined condition;

detecting at least one second touch control operation for at least one object in an area of the touch control display unit, during the time the first position is in the touch-controlled state;

generating and executing a control instruction based on the first touch control point and the at least one second touch control operation, so as to perform a control operation corresponding to the control instruction on the at least one object.

In the technical solution of the present application, the first touch control operation of the first operator on the first position of the touch control display unit is detected; it is determined whether the first touch control operation meets the first predetermined condition, so as to obtain the first determination result; when the first determination result is Yes, the first position is controlled to be in the touch-controlled state so as to become the first touch control point; during the time the first position is in the touch-controlled state, the at least one second touch control operation is detected; the control instruction is generated and executed based on the first touch control point and the second touch control operation, so as to solve the technical problem that conventionally, the single hand cannot implement the multipoint touch control operation, achieving the technical effect of using the first touch control point for replacing one of touch control points in the multipoint touch control and thus of implementing the multipoint touch control by the single hand.

Hereinafter, the technical solutions of the present application will be described in detail in connection with particular embodiments with reference to the drawings. It should be understood that the embodiments of the present application and specific features in the embodiments are detailed explanations of the technical solutions in the present application, but are not limitations thereon. The embodiments of the present application and the specific features in the embodiments may be appropriately combined, if possible.

The embodiments of the present application provide an information processing method and an electronic device. In a particular implementation, the electronic device may be a smart phone, a tablet or a notebook, as long as there is a particular touch control display unit. The embodiments of the present application do not make any particular limitation to this. In the following description, the tablet will be taken as an example for a detailed description on the information processing method and the electronic device according to the embodiments of the present application.

### First Embodiment

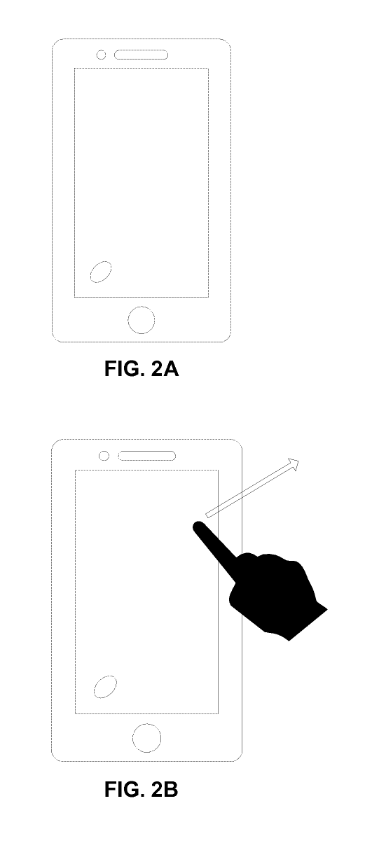

Before the information processing method according to the embodiment of the present application is introduced, a basic structure of the electronic device to which the method according to the embodiment of the present application is introduced. With reference to FIG. 2, the electronic device in the embodiment of the present application has a touch control display unit 1, and further comprises:

a first detection unit 2, configured to detect a first touch control operation of a first operator on a first position of a touch control display unit;

a first determination unit 3, configured to determine whether the first touch control operation meets a first predetermined condition, so as to obtain a first determination result;

a first control unit 4, configured to control the first position to be in a touch-controlled state so as to become a first touch control point, when the first determination result indicates that the first touch control operation meets the first predetermined condition;

a second detection unit 5, configured to detect at least one second touch control operation for at least one object in an area of the touch control display unit, during the time the first position is in the touch-controlled state;

a first performing unit 6, configured to generate and execute a control instruction based on the first touch control point and the at least one second touch control operation, so as to perform a control operation corresponding to the control instruction on the at least one object.

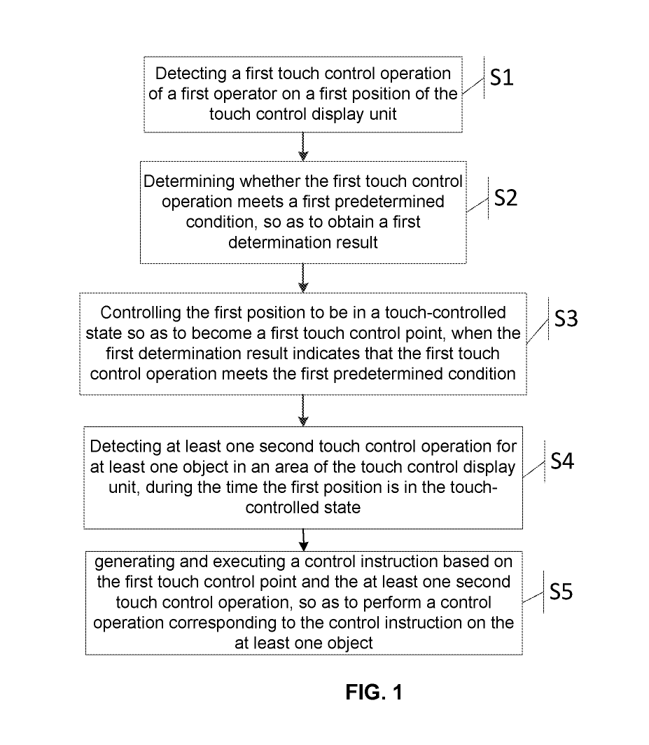

Hereinafter, the information processing method according to the embodiment of the present application will be described in detail. Firstly, as shown in FIG. 1, the information processing method according to the embodiment of the present application comprises steps as follows.

At step S1, a first touch control operation of a first operator on a first position of the touch control display unit is detected.

In particular, in the embodiment of the present application, when the user performs the touch control operation on the touch control display unit using an operator such as a finger, a palm, a sensor (such as a capacitance sensor and a resistance sensor), which is beneath and connected to the touch control display unit, detects that there is a touch control operation on a surface of the touch control display unit. Then, the method proceeds to step S2.

At step S2, it is determined whether the first touch control operation meets a first predetermined condition, so as to obtain a first determination result.

In the embodiment of the present application, how to determine whether the first touch control operation meets the first predetermined condition is particularly determining, according to a first value of a first parameter corresponding to the first touch control operation, whether the first value is larger than a predetermined value, so as to obtain the first determination result.

There are various ways of determining whether the first value is larger than the predetermined value. Hereinafter, three different ways are listed for illustration, but the particular implementations are not limited to these.

(1) It may be determined whether stress corresponding to the first touch control operation is beyond predetermined stress.

In particular, when the first parameter is particularly the stress corresponding to the first touch control operation, the touch control display unit obtains a first value corresponding to the stress of the first touch control operation to be compared with the predetermined stress, after it detects the first touch control operation. For example, if the predetermined stress is 0.08N, and the first value corresponding to the detected stress of the first touch control operation is 0.98N, the first value is larger than the predetermined stress, and thus the first determination result is Yes; and if the predetermined stress is 0.08N, and the first value corresponding to the detected stress of the first touch control operation is 0.72N, the first value is smaller than the predetermined stress, and thus the first determination result is No; if the predetermined stress is 0.1N, and the first value corresponding to the detected stress of the first touch control operation is 0.21N, the first value is larger than the predetermined stress, and thus the first determination result is Yes.

(2) It may be determined whether a touch control area corresponding to the first touch control operation is larger than a predetermined area.

In particular, when the first parameter is particularly the touch control area corresponding to the first touch control operation, the touch control display unit obtains the touch control area corresponding to the first touch control operation to be compared with the predetermined area, after it detects the first touch control operation. For example, if the predetermined area is 1.6 cm², the detected touch control area (i.e. the first value) corresponding to the first touch control operation is 1.49 cm², the touch area is smaller than the predetermined area, and thus the first determination result is No; and if the predetermined area is 1.67 cm², the detected touch control area (i.e. the first value) corresponding to the first touch control operation is 1.7 cm², the touch area is larger than the predetermined area, and thus the first determination result is Yes; if the predetermined area is 1.95 cm², the detected touch control area (i.e. the first value) corresponding to the first touch control operation is 2 cm², the touch area is larger than the predetermined area, and thus the first result is Yes.

(3) It may be determined whether a touch control time period corresponding to the first touch control operation is beyond a predetermined time period.

In particular, when the first parameter is particularly the touch control time period corresponding to the first touch control operation, the touch control display unit obtains the touch control time period corresponding to the first touch control operation to be compared with the predetermined time period, after it detects the first touch control operation. For example, if the predetermined time period is 2 s, the detected touch control time period (i.e. the first value) corresponding to the first touch control operation is 3 s, the first value is larger than the predetermined time period, and thus the first determination result is Yes; if the predetermined time period is 2 s, the detected touch control time period (i.e. the first value) corresponding to the first touch control operation is 1.9 s, the first value is smaller than the predetermined time period, and thus the first determination result is No; if the predetermined time period is 3 s, the detected touch control time period (i.e. the first value) corresponding to the first touch control operation is 3 s, the first value is equal to the predetermined time period, and thus the first determination result is Yes.

Of course in particular implementations, the skilled in the art may select first parameter and setting of the corresponding predetermined value according to actual requirements. The present application is not limited to this.

After the first determination result is obtained in step S2, the method proceeds to step S3.

At step S3, the first position is controlled to be in a touch-controlled state so as to become a first touch control point, when the first determination result indicates that the first touch control operation meets the first predetermined condition;

In particular implementations, there are various ways for controlling the first position to be in the touch-controlled state so as to become the first touch control point. Hereinafter, two different ways are listed for illustration, but the particular implementations are not limited to these.

In the first way, a second control signal is transmitted once by the control unit for controlling the first position to be in the touch-controlled state, which particularly comprises steps of:

1) transmitting, by the touch control display unit, first touch control information corresponding to the first touch control operation to a control unit connected to the touch control display unit.

In particular, in the embodiment of the present application, the first touch control information transmitted by the touch control display unit to the control unit may be particularly specific coordinates of the first position of the first touch control operation on the touch control display unit, e.g. the first position is (3, 2) or (3, 3), where a unit of the coordinates is cm, and a coordinate origin is a lower-left corner of the touch control display unit; or the first touch control information may be particularly a shape or an area of a contact surface of the first operator contacted with the touch control display unit when the first operator performs the first touch control operation, e.g. an ellipse of 0.18 cm², and may also be at least one coordinate of the contact surface, e.g. coordinates of all points corresponding to the ellipse as shown in the lower-left of FIG. 2A. In particular implementations, the skilled in the art may select according to actual requirements. The present application is not limited to this.

2) controlling, by the touch control display unit, the first position to be in the touch-controlled state so as to become the first touch control point, according to a first control signal transmitted by the control unit.

After the control unit receives the first touch control information, the first control signal is transmitted to the touch control display unit according to the first touch control information, and the touch control display unit controls the first position to be in the touch-controlled state for a certain time period, e.g. 2 s, according to the first control signal. In particular, in the embodiment of the present application, the first control information is control information which may control the first position to be in the touch-controlled state for a certain time, e.g. 2 s, 3 s etc. The first control information may comprise particular coordinates of the first position, e.g. (3, 2) or (3, 3), where the unit of the coordinates is cm, and the coordinate origin is the lower-left corner of the touch control display unit; or an area or a shape of a region in a controlled state, e.g. an ellipse of 18 cm²; and may also be at least one coordinate of the contact surface, e.g. coordinates of all points corresponding to the ellipse as shown in the lower-left of FIG. 2A. In particular implementations, the skilled in the art may select according to actual requirements. The present application is not limited to this.

In the second way, third control information transmitted by the control unit is received at least once by transmitting the first touch control information at least once to the control unit, so as to control the first position to be in the touch-controlled state, which particularly comprises steps of:

1) transmitting, by the touch control display unit, the first touch control information at least once to the control unit.

In particular, in the embodiment of the present application, the first touch control information transmitted by the touch control display unit to the control unit may be particularly specific coordinates of the first position of the first touch control operation on the touch control display unit, e.g. the first position is (3, 2) or (3, 3), where a unit of the coordinates is cm, and a coordinate origin is a lower-left corner of the touch control display unit; or the first touch control information may be particularly the shape or the area of the contact surface of the first operator contacted with the touch control display unit when the first operator performs the first touch control operation, e.g. an ellipse shape with an area of 2 cm²; and may also be at least one coordinate of the contact surface, e.g. coordinate values of each point in the ellipse as shown in FIG. 2A. In particular implementations, the skilled in the art may select according to actual requirements. The present application is not limited to this.

The touch control display unit transmits to the control unit the first touch control information at least once, e.g. 100 times, 80 times, 45 times etc., so that the control unit may control the first position to be in the touch-controlled state for a certain time period.

2) receiving, by the touch control display unit, at least one third control signal transmitted by the control unit.

In particular, in the embodiment of the present application, the number of the third control signals transmitted by the control unit should be equal to the number of pieces of the first control information transmitted by the touch control display unit to the control unit. That is, when the touch control display unit transmits the first touch control information 100 times to the control unit, the third control information will be received 100 times; or when the touch control display unit transmits the first touch control information 90 times to the control unit, the third control information will be received 90 times.

3) controlling, by the touch control display unit, the first position to be in the touch-controlled state so as to become the first touch control point, according to the third touch control signal.

In particular, the touch control display unit controls the first position to be in the touch-controlled state so as to become the first touch control point, according to the third touch control information, in which the third control information is particularly control information for controlling the first position to be in the controlled state immediately. This implementation is a conventional solution, and thus the description thereof is omitted here.

After step S3 is completed, i.e. the first position is controlled to be in the touch-controlled state, the method proceeds to step S4.

At step S4, at least one second touch control operation is detected for at least one object in an area of the touch control display unit, during the time the first position is in the touch-controlled state.

In particular, in the embodiment of the present application, as shown in FIG. 2B, when the first position is in the touch-controlled state, the touch control display unit obtains at least one second touch control operation for at least one (e.g. one or two) object. After the second touch control operation is detected, the method proceeds to step S5. In particular implementations, in order to facilitate the operation of the user, the first position of the touch control display unit may be displayed to be black or grey or an edge of the first position may be displayed to be a closed curve. The present application does not make any limitation to the particular display approach.

At step S5, a control instruction is generated and executed based on the first touch control point and the at least one second touch control operation, so as to perform a control operation corresponding to the control instruction on the at least one object.

After the second touch control operation is detected, the control instruction, such as a picture zoom-in instruction, a picture zoom-out instruction and an object rotation instruction etc., is generated and executed based on the first touch control point and the second touch control operation.

Hereinafter, the above steps will be described in several particular application scenarios.

Scenario One:

Assuming that one picture is displayed on the touch control display unit, the implementation of obtaining the first determination result being the first way as listed in the embodiment and the implementation of controlling the first position to be in the touch-controlled state being the first way are taken as an example. When the user holds the breakfast by one hand, he can only perform the touch control operation by the other hand. Firstly, the user presses once on the touch control display unit using his forefinger of the right hand. The touch control display unit detects the first touch control operation. The stress of the touch control operation is 0.08N, and here the predetermined stress is 0.08N, thus the first determination result is yes. The touch control display unit transmits to the control unit the first touch control information of the first touch control operation, including the shape of the contact surface between the user's forefinger of the right hand the touch control display unit (which is assumed to be approximately an ellipse, as shown in FIG. 2A) and the coordinates corresponding to all of the touch control points within the contact surface. The control unit transmits the first control information to the touch control display unit for controlling the approximate ellipse region to be in the touch-controlled state. Next, the user performs the second touch control operation in other region outside the ellipse region using his forefinger of the right hand, and the sliding direction of the second touch control operation is shown in FIG. 2B. The control unit generates and executes the picture zoom-in instruction based on the second operation and the first touch control point, and the picture thus is zoomed in.

Scenario Two:

Assuming that the approach of obtaining the first determination result is to determine whether the touch control area is larger than the predetermined area, and controlling the first position to be in the touch-controlled state is the second way. Many files are displayed dispersedly on the desktop of the tablet. The user needs to put these files together by a sliding-to-center operation on the touch control display unit using two hands. However, the user only has his left hand available to operate at this time. The user firstly puts the palm of his left hand on the touch control display unit. The touch control display unit obtains the touch control area of the user's palm. Assuming that the touch control area is 145.88 cm², and the predetermined area is 100 cm², the first determination result is yes. Further, the touch control display unit transmits to the control unit the first touch control information, i.e., the touch control area and the coordinates of each point within the touch control area, 50 times. Each time the control unit receives the first touch control information, the third control information is returned to the touch control display unit once. Thus, the third control information is returned 50 times in total. Between transmitting the first touch control information 50 times and returning the third control information 50 times, the contact surface is in the touch-controlled state. During this period, the user's left hand is put on the second position besides the first position, by which the touch control operation of moving to the center of the touch control display unit is performed. Thus, the files on the desktop are put together.

Scenario Three:

Assuming that one picture is displayed on the touch control display unit, the implementation of obtaining the first determination result being the third way as listed in the embodiment and the implementation of controlling the first position to be in the touch-controlled state being the first way are taken as an example. When the user holds the breakfast by one hand, he can only perform the touch control operation by the other hand. Firstly, the user puts the palm of the left hand on the touch control display unit. The touch control display unit obtains the touch control time period of the user's palm. Assuming that the touch control time period of the user's palm is 3 s, and the predetermined time period is 3.5 s, the first determination result is yes. The touch control display unit transmits to the control unit the first touch control information, i.e., the touch control area and the coordinates of each point within the touch control area. The control unit transmits the first control information to the touch control display unit for controlling the corresponding region of the palm to be in the touch-controlled state. The electronic device displays the edge of the contact surface to be red. Next, the user performs a moving touch control operation along a semicircle whose center is the center of the contact surface using his forefinger of the left hand. Then, the electronic device generates and executes an instruction of rotating the picture by 180°.

After step S5 is completed, it is required to control the first position to resume to a non-touch-controlled state from the touch-controlled state. There are various ways in the particular implementations. Hereinafter, two ways corresponding to the above approaches are illustrated. The present application is not limited to these.

The first way comprises steps of:

1) obtaining, by the touch control display unit, a duration where the first position is in the touch-controlled state and transmitting the duration to the control unit.

When the first position is in the touch-controlled state, the time period where the first position is in the touch-controlled state is obtained and transmitted to the control unit.

2) determining, by the control unit, whether the duration is no less than a predetermined period.

The control unit determines whether the duration is longer than the predetermined period according to the duration transmitted by the touch control display unit, i.e. determines whether the time period where the first position is in the touch-controlled state is long enough. In particular, in the embodiment of the present application, the predetermined period may be 1 s, 1.5 s or 2 s. Of course, the skilled in the art may select according to the actual requirements. The present application is not limited to this.

3) transmitting, by the control unit, a second control signal different from the first control signal to the touch control display unit, when the duration is no less than the predetermined period;

In particular, in the embodiment of the present application, when the duration is longer than the predetermined period, the control unit transmits the second control signal to the touch control display unit for controlling the first position to be in the non-touch-controlled state from the touch-controlled state. For example, the touch control display unit detects that the duration where the first position is in the touch-controlled state is 2 s, and the predetermined period is 1.999 s. The duration is longer than the predetermined period. Thus, the control unit transmits the second control information to the touch control display unit. The touch control display unit detects that the duration where the first position is in the touch control state is 1.5 s, and the predetermined period is 1.999 s. The duration is not longer than the predetermined period. Thus, the control unit would not transmit the second control information to the touch control display unit. The touch control display unit detects that the duration where the first position is in the touch control state is 1.5 s, and the predetermined period is 1.5 s. The duration is equal to the predetermined period. Thus, the control unit transmits the second control information to the touch control display unit. More examples will not be listed here.

4) controlling, by the touch control display unit, the first position to be adjusted from the touch-controlled state to a non-touch-controlled state, according to the second control signal.

After the second control information is received, the touch control display unit controls the first position to be adjusted from the touch-controlled state to the non-touch-controlled state to facilitate the user's subsequent operations.

The second way comprises steps of:

1) obtaining, by the touch control display unit, a duration where the first position is in the touch-controlled state, and transmitting the duration to the control unit.

When the first position is in the touch-controlled state, the duration where the first position is in the touch-controlled state is obtained and transmitted to the control unit.

2) determining, by the control unit, whether the duration is no less than a predetermined period.

The control unit determines whether the duration is longer than the predetermined period according to the duration transmitted by the touch control display unit, i.e. determines whether the time period where the first position is in the touch-controlled state is long enough. In particular, in the embodiment of the present application, the predetermined period may be 1 s, 1.5 s or 2 s. Of course, the skilled in the art may select according to the actual requirements. The present application is not limited to this.

3) transmitting, by the control unit, a second control signal different from the first control signal to the touch control display unit, when the duration is no less than the predetermined period;

In particular, in the embodiment of the present application, when the duration is longer than the predetermined period, the control unit transmits the second control signal to the touch control display unit for controlling the first position to be in the non-touch-controlled state from the touch-controlled state. For example, the touch control display unit detects that the duration where the first position is in the touch-controlled state is 2 s, and the predetermined period is 1.999 s. The duration is longer than the predetermined period. Thus, the control unit transmits the second control information to the touch control display unit. The touch control display unit detects that the duration where the first position is in the touch control state is 1.5 s, and the predetermined period is 1.999 s. The duration is not longer than the predetermined period. Thus, the control unit would not transmit the second control information to the touch control display unit. The touch control display unit detects that the duration where the first position is in the touch control state is 1.5 s, and the predetermined period is 1.5 s. The duration is equal to the predetermined period. Thus, the control unit transmits the second control information to the touch control display unit. More examples will not be listed here.

4) controlling, by the touch control display unit, the first position to be adjusted from the touch-controlled state to a non-touch-controlled state, according to the second control signal.

After the second control information is received, the touch control display unit controls the first position to be adjusted from the touch-controlled state to the non-touch-controlled state to facilitate the user's subsequent operations.

### Second Embodiment

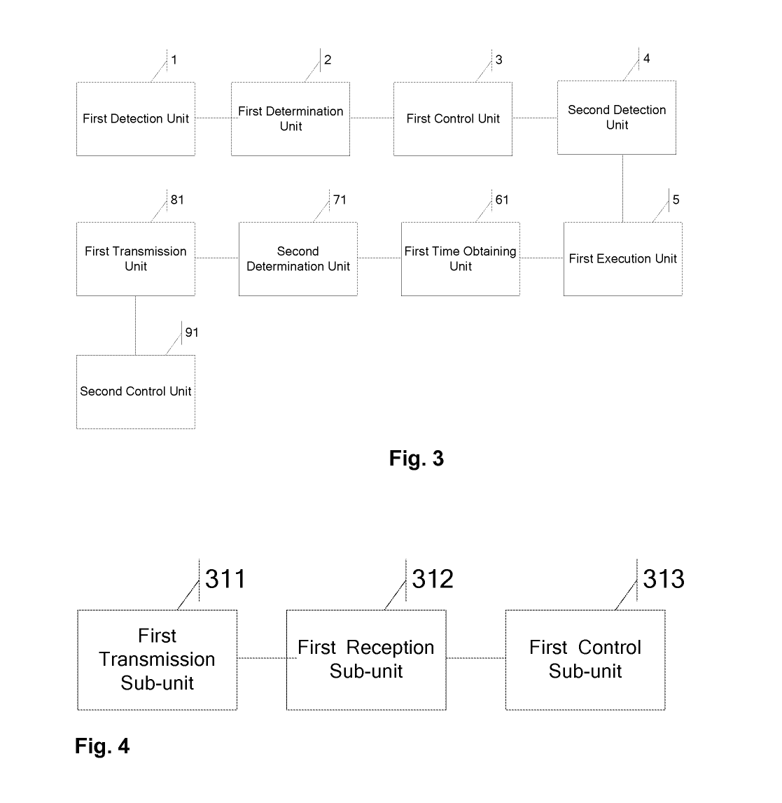

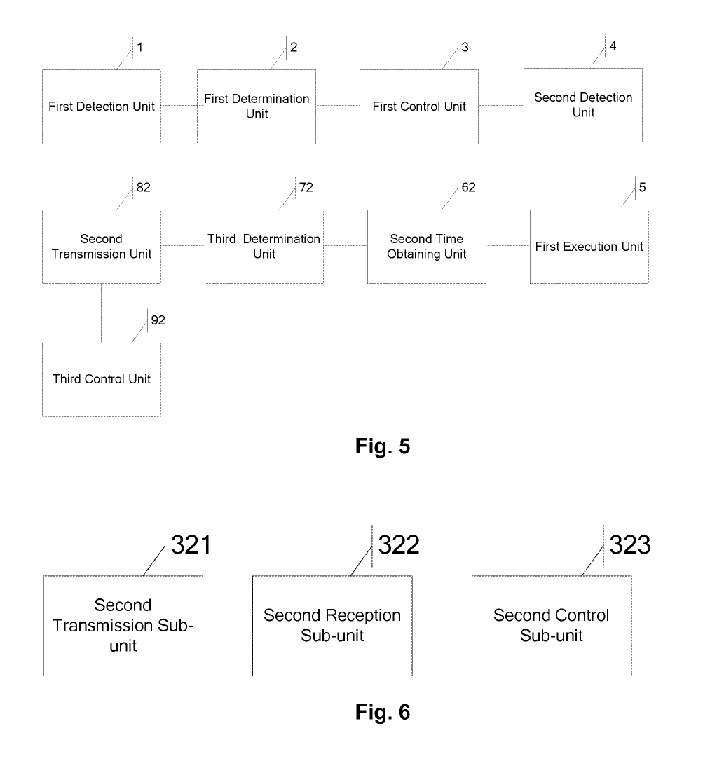

With reference to FIG. 3, the embodiment of the present application provides an electronic device including a touch control display unit 1, which may be a capacitance touch control display unit, and a resistance touch control display unit, may also be an infrared touch control display unit. The present application is not limited to this.

Further, the electronic device further comprises:

a first detection unit 1, configured to detect a first touch control operation of a first operator on a first position of a touch control display unit;

a first determination unit 2, configured to determine whether the first touch control operation meets a first predetermined condition, so as to obtain a first determination result;

a first control unit 3, configured to control the first position to be in a touch-controlled state so as to become a first touch control point, when the first determination result indicates that the first touch control operation meets the first predetermined condition;

a second detection unit 4, configured to detect at least one second touch control operation for at least one object in an area of the touch control display unit, during the time the first position is in the touch-controlled state;

a first performing unit 5, configured to generate and execute a control instruction based on the first touch control point and the at least one second touch control operation, so as to perform a control operation corresponding to the control instruction on the at least one object.

In a particular implementation, the first determination unit 2 may be a parameter value determination unit for determining, according to a first value of a first parameter corresponding to the first touch control operation, whether the first value is larger than a predetermined value, so as to obtain the first determination result.

Further, the first control unit 3 particularly comprises:

a first transmission sub-unit 311, configured to transmit first touch control information corresponding to the first touch control operation to a control unit connected to the touch control display unit;

a first reception sub-unit 312, configured to receive a first control signal transmitted from the control unit;

a first control sub-unit 313, configured to control the first position to be in the touch-controlled state so as to become the first touch control point, according to the first control signal.

In the embodiment of the present application, when the first control unit 3 of the electronic device particularly comprises the first transmission sub-unit 311, the first reception sub-unit 312, the first control sub-unit 313, the electronic device further comprises:

a first time obtaining unit 61, configured to obtain a duration in which the first position is in the touch-controlled state and transmitting the duration to the control unit;

a second determination unit 71, configured to determine whether the duration is no less than a predetermined period;

a first transmission unit 81, configured to transmit a second control signal different from the first control signal to the touch control display unit, when the duration is no less than the predetermined period;

a second control unit 91, configured to control the first position to be adjusted from the touch-controlled state to a non-touch-controlled state, according to the second control signal.

Of course in the particular implementation, the first control unit 3 may further comprises:

a second transmission sub-unit 321, configured to transmit the first touch control information at least once to the control unit;

a second reception sub-unit 322, configured to receive at least one third control signal transmitted by the control unit;

a second control sub-unit 323, controlling the first position to be in the touch-controlled state so as to become the first touch control point, according to the third touch control signal.

In the embodiment of the present application, when the first control unit 3 of the electronic device particularly comprises the second transmission sub-unit 321, the second reception sub-unit 322, the second control sub-unit 323, the electronic device further comprises:

a second time obtaining unit 62, configured to obtain a duration where the first position is in the touch-controlled state, and transmit the duration to the control unit;

a third determination unit 72, configured to determine whether the duration is no less than a predetermined period;

a second transmission unit 82, configured to transmit a second control signal different from the first control signal to the touch control display unit, when the duration is no less than the predetermined period;

a third control unit 92, configured to control the first position to be adjusted from the touch-controlled state to a non-touch-controlled state, according to the second control signal.

The above one or more technical solutions of the embodiments of the present application at least have one or more technical effects as follows:

1. In the technical solutions of the present application, a first touch control operation of a first operator on a first position of the touch control display unit is detected; it is determined whether the first touch control operation meets a first predetermined condition, so as to obtain a first determination result; the first position is controlled to be in a touch-controlled state so as to become a first touch control point, when the first determination result is Yes; at least one second touch control operation is detected when the first position is in the touch-controlled state; a control instruction is generated and executed based on the first touch control point and the second touch control operation. Thus, the technical problem that conventionally, the single hand cannot implement the multipoint touch control operation may be solved, and the technical effect of using the first touch control point for replacing one of touch control points in the multipoint touch control and thus of implementing the multipoint touch control by the single hand may be achieved.

2. In the technical solutions of the present application, the touch control display unit transmits the first touch control information to the control unit, receives first control information transmitted by the control unit, and controls the first position to be in the touch-controlled state according to the first touch control information; the touch control display unit transmits the first touch control information at least once to the control unit, and receives the at least one third control signal transmitted by the control unit, and controls the first position to be in the touch-controlled state according to the third control signal. Thus, the present application provides a plurality of approaches for controlling the first position to be in the touch-controlled state, and achieves the technical effect of implementing the multipoint touch control by the single hand.

3. Further, since the technical solutions of the present application have the technical effects as discussed above, a user experience better than that in the prior art may be obtained, when the user performs the touch control operation on the electronic device.

It may be appreciated by the skilled in the art that the embodiments of the present disclosure may be implemented as a method, a system or a computer program product. The present disclosure may include pure hardware embodiments, pure software embodiments and any combination thereof. Also, the present disclosure may include a computer program product implemented on one or more computer readable storage medium (including, but not limited to, magnetic disk storage, CD-ROM, optical storage) containing computer readable program codes.

The present disclosure have been described with reference to the flowcharts and/or block diagrams of the method, device (system) and computer program product according to the embodiments of the present disclosure. It may be appreciated that each process and/or block in the flowcharts and/or block diagrams, or any combination thereof, may be implemented by computer program instructions. Such computer program instructions may be provided to a general computer, a dedicated computer, an embedded processor or a processor of any other programmable data processing device to constitute a machine, such that the instructions executed by the computer or the processor of any other programmable data processing device may constitute means for implementing the functions specified by one or more processes in the flowcharts and/or one or more blocks in the block diagrams.

These computer program instructions may also be stored in a computer readable memory that may direct a computer or any other programmable data processing device to operate in a particular way. Thus, the instructions stored in the computer readable memory constitute an article of manufacture including instruction means for implementing the functions specified by one or more processes in the flowcharts and/or one or more blocks in the block diagrams.

These computer program instructions may also be loaded onto a computer or any other programmable data processing device, such that the computer or the programmable data processing device may perform a series of operations/steps to achieve a computer-implemented process. In this way, the instructions executed on the computer or the programmable data processing device may provide steps for implementing the functions specified by one or more processes in the flowcharts and/or one or more blocks in the block diagrams.

In particular, the computer program instructions for implementing the information processing method according to the embodiment of the present disclosure may be stored on a storage medium such as an optical disc, a hard disk or a U disc. The computer program instructions stored in the storage medium for implementing the information processing method include, when read or executed by an electronic device, the following steps of:

detecting a first touch control operation of a first operator on a first position of the touch control display unit;

determining whether the first touch control operation meets a first predetermined condition, so as to obtain a first determination result;

controlling the first position to be in a touch-controlled state so as to become a first touch control point, when the first determination result indicates that the first touch control operation meets the first predetermined condition;

detecting at least one second touch control operation for at least one object in an area of the touch control display unit, during the time the first position is in the touch-controlled state;

generating and executing a control instruction based on the first touch control point and the at least one second touch control operation, so as to perform a control operation corresponding to the control instruction on the at least one object.

Alternatively, the step of determining whether the first touch control operation meets the first predetermined condition so as to obtain the first determination result is particularly a step of:

determining, according to a first value of a first parameter corresponding to the first touch control operation, whether the first value is larger than a predetermined value, so as to obtain the first determination result.

Alternatively, the computer program instructions stored in the storage medium corresponding to the step of controlling the first position to be in the touch-controlled state so as to become the first touch control point when the first determination result indicates that the first touch control operation meets the first predetermined condition, when executed, particularly include steps of:

transmitting, by the touch control display unit, first touch control information corresponding to the first touch control operation to a control unit connected to the touch control display unit;

controlling, by the touch control display unit, the first position to be in the touch-controlled state so as to become the first touch control point, according to a first control signal transmitted by the control unit.

Alternatively, some other computer instructions are stored in the storage medium, which are performed after the step of generating and executing the control instruction based on the first touch control point and the at least one second touch control operation, so as to perform a control operation corresponding to the control instruction on the at least one object. When executed, these computer instructions particularly include steps of:

obtaining, by the touch control display unit, a duration where the first position is in the touch-controlled state and transmitting the duration to the control unit;

determining, by the control unit, whether the duration is no less than a predetermined period;

transmitting, by the control unit, a second control signal different from the first control signal to the touch control display unit, when the duration is no less than the predetermined period;

controlling, by the touch control display unit, the first position to be adjusted from the touch-controlled state to a non-touch-controlled state, according to the second control signal.

Alternatively, the computer program instructions stored in the storage medium corresponding to the step of controlling the first position to be in the touch-controlled state so as to become the first touch control point when the first determination result indicates that the first touch control operation meets the first predetermined condition, when executed, particularly include steps of:

transmitting, by the touch control display unit, the first touch control information at least once to the control unit;

receiving, by the touch control display unit, at least one third control signal transmitted by the control unit;

controlling, by the touch control display unit, the first position to be in the touch-controlled state so as to become the first touch control point, according to the third touch control signal.

Alternatively, some other computer instructions are stored in the storage medium, which are performed after the step of generating and executing the control instruction based on the first touch control point and the at least one second touch control operation, so as to perform a control operation corresponding to the control instruction on the at least one object. When executed, these computer instructions particularly include steps of:

obtaining, by the touch control display unit, a duration where the first position is in the touch-controlled state, and transmitting the duration to the control unit;

determining, by the control unit, whether the duration is no less than a predetermined period;

transmitting, by the control unit, a second control signal different from the first control signal to the touch control display unit, when the duration is no less than the predetermined period;

controlling, by the touch control display unit, the first position to be adjusted from the touch-controlled state to a non-touch-controlled state, according to the second control signal.

Obviously, various modifications and variants may be made to the present disclosure by those skilled in the art without departing from the spirit and scope of the present disclosure. Therefore, these modifications and variants are to be encompassed by the present disclosure if they fall within the scope of the present disclosure as defined by the claims and their equivalents.

I/We claim:

1. An information processing method applied in an electronic device, the electronic device including a touch control display unit, the method comprising steps of:
detecting a first touch control operation of a first operator on a first position of the touch control display unit;
determining whether the first touch control operation meets a first predetermined condition, so as to obtain a first determination result;
controlling the first position to be in a touch-controlled state so as to become a first touch control point, if the first determination result indicates that the first touch control operation meets the first predetermined condition;
detecting at least one second touch control operation for at least one object in an area of the touch control display unit, during the time the first position is in the touch-controlled state;
generating and executing a control instruction based on the first touch control point and the at least one second touch control operation, so as to perform a control operation corresponding to the control instruction on the at least one object.

2. The method according to claim 1, wherein the step of determining whether the first touch control operation meets the first predetermined condition so as to obtain the first determination result comprises:
determining, according to a first value of a first parameter corresponding to the first touch control operation, whether the first value is larger than a predetermined value, so as to obtain the first determination result.

3. The method according to claim 2, wherein the step of controlling the first position to be in the touch-controlled state so as to become the first touch control point if the first determination result indicates that the first touch control operation meets the first predetermined condition comprises:
transmitting, by the touch control display unit, first touch control information corresponding to the first touch control operation to a control unit connected to the touch control display unit;
controlling, by the touch control display unit, the first position to be in the touch-controlled state so as to become the first touch control point, according to a first control signal transmitted by the control unit.

4. The method according to claim 3, wherein after the step of generating and executing the control instruction based on the first touch control point and the at least one second touch control operation, so as to perform a control operation corresponding to the control instruction on the at least one object, the method further comprises steps of:
obtaining, by the touch control display unit, a duration in which the first position is in the touch-controlled state and transmitting the duration to the control unit;
determining, by the control unit, whether the duration is no less than a predetermined period;
transmitting, by the control unit, a second control signal different from the first control signal to the touch control display unit, when the duration is no less than the predetermined period;
controlling, by the touch control display unit, the first position to be adjusted from the touch-controlled state to a non-touch-controlled state, according to the second control signal.

5. The method according to claim 2, wherein the step of controlling the first position to be in the touch-controlled state so as to become the first touch control point if the first determination result indicates that the first touch control operation meets the first predetermined condition comprises:
transmitting, by the touch control display unit, the first touch control information at least once to the control unit;
receiving, by the touch control display unit, at least one third control signal transmitted by the control unit;
controlling, by the touch control display unit, the first position to be in the touch-controlled state so as to become the first touch control point, according to the third touch control signal.

6. The method according to claim 5, wherein after the step of generating and executing the control instruction based on the first touch control point and the at least one second touch control operation, so as to perform a control operation corresponding to the control instruction on the at least one object, the method further comprises steps of:
obtaining, by the touch control display unit, a duration in which the first position is in the touch-controlled state, and transmitting the duration to the control unit;
determining, by the control unit, whether the duration is no less than a predetermined period;
transmitting, by the control unit, a second control signal different from the first control signal to the touch control display unit, when the duration is no less than the predetermined period;
controlling, by the touch control display unit, the first position to be adjusted from the touch-controlled state to a non-touch-controlled state, according to the second control signal.

7. An electronic device, comprising:
a first detection unit, configured to detect a first touch control operation of a first operator on a first position of a touch control display unit;
a first determination unit, configured to determine whether the first touch control operation meets a first predetermined condition, so as to obtain a first determination result;
a first control unit, configured to control the first position to be in a touch-controlled state so as to become a first touch control point, if the first determination result indicates that the first touch control operation meets the first predetermined condition;
a second detection unit, configured to detect at least one second touch control operation for at least one object in an area of the touch control display unit, during the time the first position is in the touch-controlled state;
a first performing unit, configured to generate and execute a control instruction based on the first touch control point and the at least one second touch control operation, so as to perform a control operation corresponding to the control instruction on the at least one object.

8. The electronic device according to claim 7, wherein the first determination unit is particularly a parameter value determination unit, configured to:
determining, according to a first value of a first parameter corresponding to the first touch control operation, whether the first value is larger than a predetermined value, so as to obtain the first determination result.

9. The electronic device according to claim 8, wherein the first control unit comprises:
a first transmission sub-unit, configured to transmit first touch control information corresponding to the first touch control operation to a control unit connected to the touch control display unit;
a first reception sub-unit, configured to receive a first control signal transmitted from the control unit;
a first control sub-unit, configured to control the first position to be in the touch-controlled state so as to become the first touch control point, according to the first control signal.

10. The electronic device according to claim 9, further comprising:
a first time obtaining unit, configured to obtain a duration where the first position is in the touch-controlled state and transmitting the duration to the control unit;
a second determination unit, configured to determine whether the duration is no less than a predetermined period;
a first transmission unit, configured to transmit a second control signal different from the first control signal to the touch control display unit, when the duration is no less than the predetermined period;
a second control unit, configured to control the first position to be adjusted from the touch-controlled state to a non-touch-controlled state, according to the second control signal.

11. The electronic device according to claim 8, wherein the first control unit particularly comprises:
a second transmission sub-unit, configured to transmit the first touch control information at least once to the control unit;
a second reception sub-unit, configured to receive at least one third control signal transmitted by the control unit;
a second control sub-unit, controlling the first position to be in the touch-controlled state so as to become the first touch control point, according to the third touch control signal.

12. The electronic device according to claim 11, further comprising:
a second time obtaining unit, configured to obtain a duration in which the first position is in the touch-controlled state, and transmit the duration to the control unit;
a third determination unit, configured to determine whether the duration is no less than a predetermined period;
a second transmission unit, configured to transmit a second control signal different from the first control signal to the touch control display unit, when the duration is no less than the predetermined period;
a third control unit, configured to control the first position to be adjusted from the touch-controlled state to a non-touch-controlled state, according to the second control signal.
